(19) United States
(12) Patent Application Publication
(10) Pub. No.: US 2020/0082388 A1
(43) Pub. Date: Mar. 12, 2020

(54) AUTHENTICATING SERVER AND METHOD FOR TRANSACTIONS ON BLOCKCHAIN

(71) Applicant: STAR BIT Innovation Co., Ltd., New Taipei City (TW)

(72) Inventors: Chung-Li WANG, New Taipei City (TW); Chun-Wei HUANG, New Taipei City (TW); Haw YUAN, New Taipei City (TW); Chi-Liang CHENG, New Taipei City (TW); Hong-Bin YANG, New Taipei City (TW); Li-Zhong YEO, New Taipei City (TW); Yu-Chieh TSENG, New Taipei City (TW)

(21) Appl. No.: 16/217,722

(22) Filed: Dec. 12, 2018

(30) Foreign Application Priority Data
Sep. 6, 2018 (TW) 107131375

(51) Int. Cl. G06Q 20/36; H04L 9/32; G06Q 20/38; G06Q 20/06

(52) U.S. Cl. CPC G06Q 20/3678; H04L 9/3247; G06Q 20/3674; G06Q 20/3825; G06Q 2220/00; G06Q 20/389; H04L 2209/38; H04L 2209/56; G06Q 20/065

(57) ABSTRACT

An authenticating server is coupled to a blockchain network is configured to: (1) receive a transaction application data from a user, wherein the transaction application data includes a wallet data containing a wallet address data and a user's signature data; (2) check whether an amount of a cryptocurrency corresponding to the wallet address data on the blockchain network is sufficient to perform the transaction; and (3) when the amount of the cryptocurrency corresponding to the wallet address data on the blockchain network is sufficient to perform the transaction, transmit a multi-signature wallet transaction data to the blockchain network for validating a blockchain operation, and send a confirmation data of the transaction associated with the transaction application data to an opposing party of the transaction. The multi-signature wallet transaction data includes the wallet address data, the user's signature data and a signature date of the authenticating server.

### CROSS REFERENCE TO RELATED APPLICATIONS

This Non-provisional application claims priority under 35 U.S.C. § 119(a) on Patent Application No(s). 107131375 filed in Taiwan, Republic of China on Sep. 6, 2018, the entire contents of which are hereby incorporated by reference.

### BACKGROUND

### Technology Field

This disclosure relates to an authenticating server and method for transactions and, in particular, to an authenticating server and method for transactions on blockchain.

### Description of Related Art

Blockchain is a decentralized digital book with a consensus algorithm, and the most widely used blockchain technology is cryptocurrency. The cryptocurrency based on blockchain technology has the characteristics of decentralization and is not regulated by central banks of different countries. At the same time, the records of cryptocurrency transactions are in principle permanent and irreversible, and can be verified and traced. For example, the traditional decentralized transaction process is initiated by a party to the transaction to sign with the user's private key, and to submit the transaction content and its digital signature to the blockchain, and the submitted data can be verified and recorded by each node. To ensure the security, the opposing party of the transaction usually does not just wait for one confirmation to conclude that the transaction has been completed. In general, the opposing party of the transaction will wait for at least 6 confirmations before the transaction is considered complete. This often takes from ten minutes to several hours. However, the cash-based transactions can take only about 3 minutes to complete, and the use of credit cards or other non-centralized virtual currency can finish the transactions within about 0.5 minutes to 1 minute. Therefore, the traditional blockchain technology needs long waiting time in cryptocurrency transactions, which cannot satisfy the parties (ordinary people) in the transactions.

However, cryptocurrencies based on blockchain technology still have other security flaws. For example, if a malicious user has a higher hash rate (e.g. 51%), he can launch a double spend attack to destroy the unmodifiability of the original transaction record, so that the transaction existing in the non-deletable block is erased and the cryptocurrency that has been “spent” can be used again. Even if, for example, the Ethereum platform using Turing's complete language Solidity, malicious users can still pay a higher “Gas” for conducting a double spend attack, so that the later transactions are record prior to the earlier transactions. Then, the earlier transactions will be determined as authentication failure because the node finds that there is not enough cryptocurrency balance when confirming the corresponding wallet address, so that the opposing party of the earlier transaction cannot obtain the consideration of the transaction.

Therefore, it is desired to provide an authenticating method for cryptocurrency transactions on blockchain that can prevent the double spend attack from malicious users and can allow the opposing party of the transaction to complete the transaction without spending a lot of time to wait the authentication.

### SUMMARY

An objective of this disclosure is to provide an authenticating server and method for transactions on blockchain that can submit the transaction to blockchain network for operation after the authenticating server confirms that the cryptocurrency balance of the user is sufficient for this transaction. This configuration can prevent the double spend attack from malicious users and can allow the opposing party of the transaction to realize whether the transaction has been confirmed or not in a short time, thereby avoiding the long waiting time for authentication.

The present disclosure provides an authenticating server for transactions on blockchain, which is coupled to a blockchain network and comprises a memory unit and one or more processing units. The memory unit stores a plurality of instructions and the one or more processing units are operatively coupled to the memory unit. The processing units are configured to execute the instructions to perform following actions of: (1) receiving a transaction application data from a user, wherein the transaction application data includes a wallet data containing a wallet address data and a user's signature data; (2) checking whether an amount of a cryptocurrency corresponding to the wallet address data on the blockchain network is sufficient to perform the transaction; and (3) when the amount of the cryptocurrency corresponding to the wallet address data on the blockchain network is sufficient to perform the transaction, transmitting a multi-signature wallet transaction data to the blockchain network for validating a blockchain operation, and sending a confirmation data of the transaction associated with the transaction application data to an opposing party of the transaction, wherein the multi-signature wallet transaction data includes the wallet address data, the user's signature data and a signature date of the authenticating server.

In addition, this disclosure also provides an authenticating method for transactions on blockchain, which comprises steps: (1) an authenticating server receiving a transaction application data from a user, wherein the transaction application data includes a wallet data containing a wallet address data and a user's signature data; (2) the authenticating server checking whether an amount of a cryptocurrency corresponding to the wallet address data on the blockchain network is sufficient to perform the transaction; and (3) when the amount of the cryptocurrency corresponding to the wallet address data on the blockchain network is sufficient to perform the transaction, the authenticating server transmitting a multi-signature wallet transaction data to the blockchain network for validating a blockchain operation, and sending a confirmation data of the transaction associated with the transaction application data to an opposing party of the transaction, wherein the multi-signature wallet transaction data includes the wallet address data, the user's signature data and a signature date of the authenticating server.

In one embodiment, the user's signature data is a digital signature of the user corresponding to the wallet address data.

In one embodiment, the transaction application data further comprises a transaction content and an opposing party data.

In one embodiment, the multi-signature wallet transaction data further comprises the transaction content and the opposing party data.

In one embodiment, when the amount of the cryptocurrency corresponding to the wallet address data on the blockchain network is insufficient to perform the transaction, the authenticating server further sends a transaction fail information to the user and does not send the multi-signature wallet transaction data to the blockchain network.

In one embodiment, the cryptocurrency is Bitcoin (BTC), Bitcoin cash (BCC), Ethereum (ETH), Litecoin (LTC), or Monero (XMR).

In one embodiment, when the amount of the cryptocurrency corresponding to the wallet address data on the blockchain network is sufficient to perform the transaction, the authenticating server further sends the confirmation data to the user.

As mentioned above, in the authenticating server and method for transactions on blockchain of this disclosure, the authenticating server checks that whether an amount of a cryptocurrency balance of the user is sufficient to perform the transaction in advance and then submits the transaction to the blockchain network for operation, thereby preventing the double spend attack from malicious users. In addition, after determining that the cryptocurrency balance of the user is sufficient to perform the transaction, the authenticating server sends the confirmation data to the opposing party of the transaction. Thus, the opposing party of the transaction can be acknowledged that the transaction has been confirmed within a short time, thereby avoiding the long waiting time.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing an authenticating server according to a first embodiment of this disclosure, which is applied to the transactions on blockchain;

FIG. 2 is a schematic diagram showing the structure of the authenticating server according to the first embodiment of this disclosure; and

FIG. 3 is a flow chart of an authenticating method according to a second embodiment of this disclosure.

### DETAILED DESCRIPTION OF THE DISCLOSURE

The present disclosure will be apparent from the following detailed description, which proceeds with reference to the accompanying drawings, wherein the same references relate to the same elements.

Unless otherwise defined, all technical and scientific terms used herein have the same meanings the same as the ordinary meanings realized by those of ordinary skill in the art. It is understood that the terminology used herein is for the purpose of description the particular embodiments and is not to limit the scope of the disclosure.

It is to be noted that all directional indications (such as up, down, left, right, front, rear and the like) in the embodiments of the present disclosure are only used for explaining the relative positional relationship, circumstances during its operation, and the like, between the various components in a certain specific posture (as shown in the accompanying drawings). If the specific posture changes, the directional indication will also change accordingly.

The term “blockchain” in this disclosure refers to transaction records that are structured on a peer-to-peer (P2P) network system and encrypted and concatenated using cryptography (each record is also called a “block”). Each block contains the encrypted hash string, time stamp, and transaction data of the previous block. In addition to the above-mentioned P2P network architecture, the blockchain technology also utilizes asymmetric encryption technology (public-private key pair), distributed ledger, and consensus-based algorithmic authentication mechanism, thereby making the block content be difficult to tamper with, and become verifiable and traceable. Therefore, a currency or goods ownership transfer transaction can be carried out directly by one party, and any financial institution or a third party institution is not involved in this transaction. Thus, it has the characteristics of decentralization. This technology is commonly used in the transactions of digital currency or cryptocurrency. In a blockchain network based on a P2P network architecture, each computer (also called a “node”) in the network has the same network computing power.

The term “cryptocurrency” in this disclosure refers to a transaction medium that uses blockchain technology, such as asymmetric encryption, decentralized ledgers, and consensus-based algorithmic authentication mechanisms, to ensure transaction security and control transaction units. The cryptocurrency is a digital currency, which can be Bitcoin (BTC), Bitcoin cash (BCC), Ethereum (ETH), Litecoin (LTC), Monroe (XMR), and etc.

The terms “wallet” and “wallet address” in this disclosure refer to the address corresponding to the cryptocurrency used in the transaction on the blockchain, in which the settlement of the currency (and currency balance) corresponding to the address is recorded. It uses the private key of the user or the owner to perform elliptic curve calculations (e.g. secp256k1), hash function operations (e.g. SHA-256), and encoding (e.g. BASE58) to obtain a string sequence containing English letters and numbers (e.g. 0x80a956Ab640Ee8A6E336C9a954bB55f422e3Ac6e). Wallets used in blockchain transactions can be created by using, for example, asymmetric cryptography, and each wallet has its own unique pair of public and private keys. The public key of each wallet can publicly allow each node to identify the wallet (e.g. transfer cryptocurrency to the wallet address), but the private key is belong to the owner of the wallet and is used to sign the transaction. For example, each node can utilize it to verify that the transaction is true or not.

The term “smart contract” means a contract defined in digital form, which is a computer protocol written in a programming language. When used in a blockchain, such as the Ethereum blockchain, the smart contract represents a computer protocol that is delivered over the Internet and can be verified and automatically executed by computers on the blockchain. The smart contracts can be executed to carry out the verified and tracked and irreversible transaction without the existing of third parties of transaction or intermediaries. For example, when the two parties sign a smart contract in the Solidity language based on the ERC20 Token Standard and deploy it on the Ethereum blockchain (hereafter referred to as the Ethernet chain) for performing operations with the Ethereum virtual machine (EVM), the computers on the Ethernet chain will perform a corresponding action according to the contract content (e.g. withdrawal from a wallet address and transfer) when a signal related to the contract (or “event”, which can be, for example, the transfer time specified in the contract, or show that one party has delivered the goods to the other party) is shown on the computers. The deployment and execution of smart contracts on the Ethernet chain require additional computing ability, which is called “Gas”, and the “Gas” can be purchased using Ethereum. Similarly, in the Ethernet chain, the corresponding actions in the smart contract are executed in response to specific events based on a consensus-type encryption and decryption algorithm. A smart contract deployed on the Ethernet chain will also have a unique address, such as “0x03f8a79ccf94611a512b63d42f5fc3eacf59d3”.

The term “multi-signature wallet” means that, in transaction on blockchain involving cryptocurrency, it is necessary to obtain more than one independent signature for a transaction, which is preferably performed based on a smart contract. In other words, if a wallet address is set as a multi-signature wallet in the form of a smart contract, and the multi-signature wallet is jointly owned by members A and B, any transaction that withdraws from the wallet address must have both signatures of member A and member B before executing. In addition, when the number of members of a multi-signature wallet is greater than or equal to 3, the minimum number of signatures required for the transaction can also be set by smart contract. That is, when the number of members of a multi-signature wallet is M (M≥3), the multi-signature wallet can be set to a transaction requiring only N members by smart contract (2≤N≤M). In this case, it is unnecessary to have the signatures of all members for the wallet address to perform the transaction.

Several exemplary embodiments will be described hereinafter.

### First Embodiment

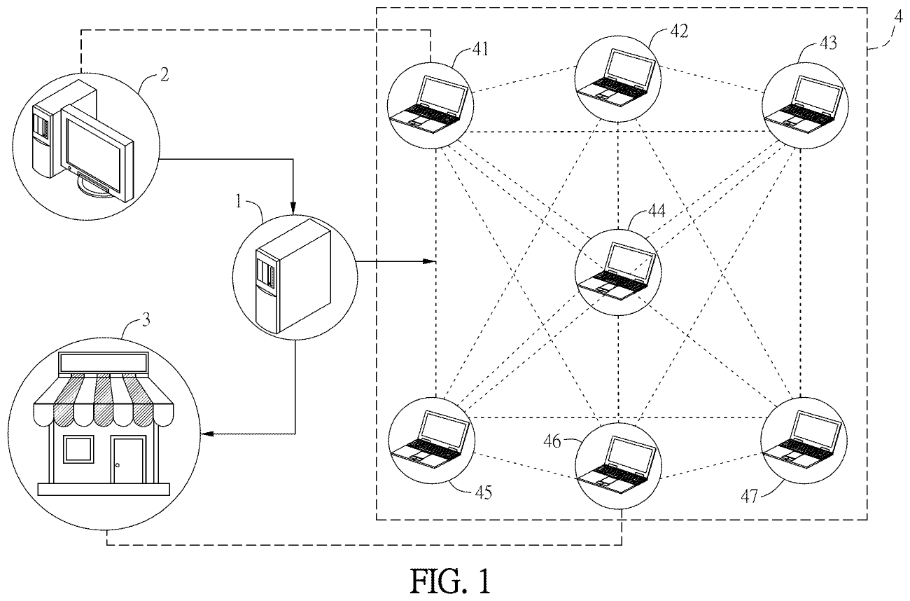

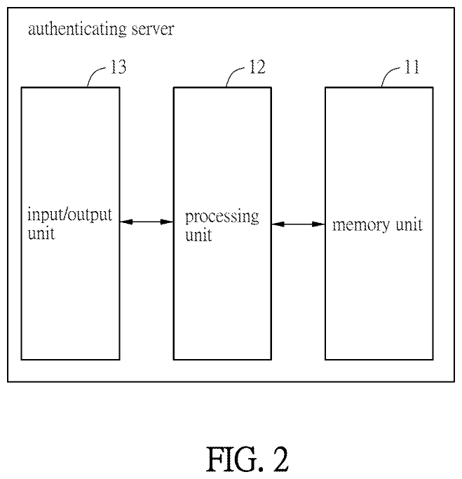

The first embodiment of this disclosure provides an authenticating server for transactions on blockchain. FIG. 1 is a schematic diagram showing an authenticating server 1 according to a first embodiment of this disclosure, which is applied to the transactions on blockchain, and FIG. 2 is a schematic diagram showing the structure of the authenticating server 1 according to the first embodiment of this disclosure. Referring to FIGS. 1 and 2, the authenticating server 1 is coupled to a blockchain network 4 and comprises a memory unit 11, and one or more processing units 12, and one or more input/output units 13. In this embodiment, for example, the authenticating server 1 comprises one processing unit 12 and one input/output unit 13. The memory unit 11 stores a plurality of instructions (e.g. program codes), and the processing unit 12 and the input/output unit 13 are operatively coupled to the memory unit 11. The memory unit 11 may be a random memory or a non-volatile computer readable storage medium. The non-volatile computer readable storage medium is, for example, a hard disk, a solid state drive (SSD), a flash memory or the likes that stores instructions (e.g. program codes) executable by the processing unit 12. The processing unit 12 can load instructions (e.g. program codes) from a non-volatile computer readable storage medium to the random memory and execute the loaded instructions. The input/output unit 13 is, for example, a network card, a network chip, a modem, or the likes that can provide network connection.

In addition, the authenticating server 1 is also coupled to the user computing device 2 and the store computing device 3 by, for example, wireless network or wired network. The user computing device 2 and the store computing device 3 can be mobile devices, notebook computers, desktop computers, devices with on-line function (e.g. smart home appliances or smart watches), or other computing devices.

As shown in figures, the blockchain network 4 includes a plurality of computers (or nodes), and the amount of the computers is not limited. To be noted, as shown in FIG. 1, the blockchain network 4 includes seven computers 14˜47. However, this is an illustration only, and is not to limit this disclosure. The user computing device 2 also connects to the blockchain network 4. As shown in FIG. 1, the user computing device 2 is connected to the computer 41 of the blockchain network 4 by wireless or wired connection, and then coupled to the entire blockchain network 4. Alternatively, the user computing device 2 can be one node of the blockchain network 4 and thus become a part of the blockchain network 4. Similarly, the store computing device 3 can also connect to the blockchain network 4. As shown in FIG. 1, the store computing device 3 is connected to the computer 47 of the blockchain network 4 by wireless or wired connection, and then coupled to the entire blockchain network 4. Alternatively, the store computing device 3 can be one node of the blockchain network 4 and thus become a part of the blockchain network 4.

The processing unit 12 is configured to read and execute the instructions stored in the memory unit 11 to control the authenticating server to perform following actions of: (1) receiving a transaction application data from the user computing device 2, wherein the transaction application data includes a wallet data containing a wallet address data and a user's signature data; (2) checking whether an amount of a cryptocurrency corresponding to the wallet address data on the blockchain network 4 is sufficient to perform the transaction; and (3) when the amount of the cryptocurrency corresponding to the wallet address data on the blockchain network 4 is sufficient to perform the transaction, transmitting a multi-signature wallet transaction data to the blockchain network 4 for validating and/or recording a blockchain operation, and sending a confirmation data of the transaction associated with the transaction application data to an opposing party of the transaction, wherein the multi-signature wallet transaction data includes the wallet address data, the user's signature data and a signature date of the authenticating server.

For example, when a user orders a goods with a price of 0.5 ETH in a store, the store is the opposing party of the transaction. In this embodiment, the store utilizes the store computing device 3 to perform this transaction. In order to pay for the ordered goods, the user can operate the user computing device 2 to issue a transaction application to the authenticating server 1 and transmit a transaction application data corresponding to the transaction. In this case, the transmitted transaction application data includes a wallet data of the user, which is used for paying this transaction, the transaction content (i.e. 0.5 ETH), and the opposing party data of the transaction, which can be the name of the store and/or the wallet address of the store for receiving the paid 0.5 ETH. To be noted, in this embodiment, the cryptocurrency can also be Bitcoin (BTC), Bitcoin cash (BCC), Litecoin (LTC) or Monero (XMR), and this disclosure is not limited.

The above-mentioned wallet data further contains a wallet address data providing the cryptocurrency for this transaction and a user's signature data. The wallet address data indicates the wallet address for paying 0.5 ETH, and the user's signature data includes the digital signature of the user associated with the transaction. The above-mentioned wallet address data is generated by a computer, which performs the above-mentioned elliptic curve calculation, hash function calculation and encoding based on a private key of the user and/or a private key of the authenticating server 1. The computer can be, for example, the user computing device 2, the authenticating server 1, or other third-party computing devices, and this disclosure is not limited thereto. At the same time, by means of smart contract, the attribute of the wallet indicated by the wallet address can be set as a multi-signature wallet, and it is specified that at least the digital signature of the user and the digital signature of the authenticating server 1 are required to make the requested payment or withdrawal. In addition, the aforementioned user's signature data (i.e. the user's digital signature for the transaction) is also generated by the user computing device 2 after performing asymmetric encryption or the likes using the user's private key. Furthermore, since the multi-signature wallet of the embodiment is constructed by means of a smart contract, the transaction application data transmitted from the user computing device 2 to the authenticating server 1 may further include the address data of the smart contract used to execute the multi-signature wallet on the blockchain network 4, so that each node of the blockchain network 4 can perform the subsequent verification.

If it is based on security considerations, the user's private key is not transmitted to the authenticating server 1, and when the wallet address corresponding to the transaction is generated, the user computing device 2 utilizes the user's private key to perform the elliptic curve calculation, hash function calculation, and encoding.

After the authenticating server 1 receives the transaction application data, it queries the nodes 41 to 47 of the blockchain network 4 to check that whether the settlement of the cryptocurrency corresponding to the wallet address indicated by the wallet address data on the records of blockchain is sufficient to pay for the transaction. That is, the authenticating server 1 will query through each node and confirm that there is enough credit in the wallet address to pay for the 0.5 ETH. The input/output unit 13 of the authentication server 1 is configured to receive the transaction application data.

When the authenticating server 1 confirms that there is a sufficient amount in the wallet address to pay the 0.5 ETH, the authenticating server 1 will send a confirmation data of the transaction to the store computing device 3, which represents that the wallet address of the user has enough credit for paying the 0.5 ETH for the transaction. At this point, the store can quickly know that the transaction has been authenticated by the authenticating server 1, thereby eliminating the need to wait for several times of confirmations (e.g., six times of confirmations) from the blockchain network 4. In addition, in a preferred embodiment, the authenticating server 1 can further transmit the confirmation data to the user computing device 2 to notify the user that the transaction has been confirmed by the authenticating server 1.

Meanwhile, the authenticating server 1 transmits the multi-signature wallet data corresponding to the transaction to the blockchain network 4, and the nodes 41 to 47 perform corresponding blockchain operations such as authentication and recording. Since the attribute of the wallet represented by the wallet address is set to the multi-signature wallet, the digital signature of the user and the digital signature of the authenticating server 1 are required to perform payment, so the multi-signature wallet data includes the signature data of the authentication server 1 and the aforementioned wallet address data, transaction content data, opposing party data, user signature data, and address data of the smart contract transmitted from the user computing device 2. Similarly, the signature data of the authenticating server 1 corresponding to the wallet address is generated by performing operations (e.g. asymmetric encryption or the likes) with the unique private key of the authenticating server 1.

In addition, when the authenticating server 1 confirms that there is not sufficient credit in the wallet address to pay for the 0.5 ETH, the authenticating server 1 sends a transaction fail information to the user computing device 2 to notify the user that there is not sufficient Ethereum in the wallet for this transaction. Thus, the user can be acknowledged to take other actions (such as adding enough cryptocurrency to the wallet address or specifying another wallet address with sufficient cryptocurrency) to continue this transaction. At the same time, the authenticating server 1 does not send the aforementioned multi-signature wallet transaction data to the blockchain network 4 for authentication and recording. In addition, the authenticating server 1 can also transmit this transaction fail information to the store computing device 3 to notify the opposing party of the transaction that the transaction has not been completed.

Accordingly, after the nodes 41 to 47 of the blockchain network 4 receive the multi-signature wallet data sent by the authenticating server 1, the nodes 41 to 47 can perform the authentication according to the user digital signature, the digital signature of the authenticating server 1 and the wallet address in the multi-signature wallet data as well as the address of the smart contract. In detailed, each of the nodes 41 to 47 decrypts the user digital signature data and the digital signature data of the authenticating server 1 by using the public key corresponding to the wallet address and then conduct the authentications. Only after confirming that the user digital signature data and the digital signature data of the authenticating server 1 are true, the payment function of the multi-signature wallet is executed according to the smart contract, and the transaction content data and the opposing party data are encrypted and encoded so as to concatenate (i.e. record) it as a new block on the existing blockchain, thereby completing the transaction. Then, the user has paid the 0.5 ETH from the user's wallet to the opposing party (i.e. the store). In addition, when recording the transaction content, each of the nodes 41-47 can also incorporate the time stamp corresponding to the transaction into the new block, so that the newly added block content is difficult to be tampered with and becomes verifiable and traceable.

### Second Embodiment

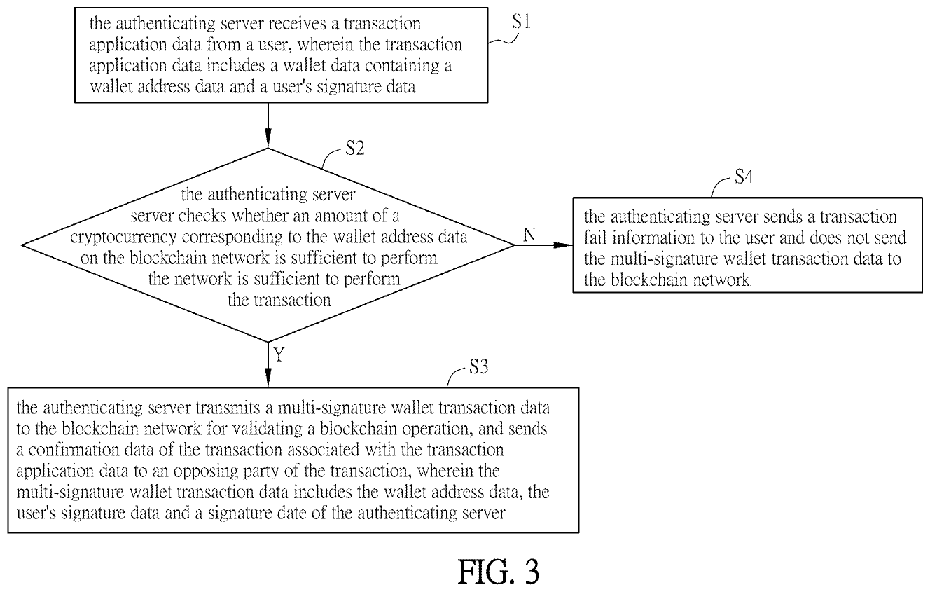

In addition, this disclosure also provides an authenticating method for transactions on blockchain, which is performed by the authenticating server 1 coupled to the blockchain network 4. FIG. 3 is a flow chart of an authenticating method according to a second embodiment of this disclosure. The authenticating method comprises a step S1: an authenticating server 1 receiving a transaction application data from a user, wherein the transaction application data includes a wallet data containing a wallet address data and a user's signature data; a step S2: the authenticating server 1 checking whether an amount of a cryptocurrency corresponding to the wallet address data on the blockchain network 4 is sufficient to perform the transaction; and a step S3: when the amount of the cryptocurrency corresponding to the wallet address data on the blockchain network is sufficient to perform the transaction, the authenticating server 1 transmitting a multi-signature wallet transaction data to the blockchain network 4 for validating a blockchain operation, and sending a confirmation data of the transaction associated with the transaction application data to an opposing party of the transaction. The multi-signature wallet transaction data includes the wallet address data, the user's signature data and a signature date of the authenticating server.

In addition, the components and connection relationship of the authenticating server 1, the user computing device 2, the store computing device 3, and the blockchain network 4 used in the authenticating method of the present embodiment, and the variations of the authenticating method of the present embodiment can be referred to the previous embodiment, and details thereof are not described herein again.

In summary, according to the above-mentioned architecture, the authenticating server 1 and authenticating method of this disclosure will check that whether an amount of a cryptocurrency balance of the user is sufficient to perform the transaction in advance and then submit the transaction to the blockchain network 4 for operation after the confirmation step, thereby preventing the double spend attack from malicious users. In addition, after determining that the cryptocurrency balance of the user is sufficient to perform the transaction, the authenticating server 1 sends the confirmation data to the opposing party of the transaction. Thus, the opposing party of the transaction can be acknowledged that the transaction has been confirmed within a short time, thereby avoiding the long waiting time.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. An authenticating server for transactions on blockchain, which is coupled to a blockchain network and comprises a memory unit and one or more processing units, wherein the memory unit stores a plurality of instructions and the one or more processing units are operatively coupled to the memory unit, and the processing units are configured to execute the instructions to perform following actions of:
receiving a transaction application data from a user, wherein the transaction application data includes a wallet data containing a wallet address data and a user's signature data;
checking whether an amount of a cryptocurrency corresponding to the wallet address data on the blockchain network is sufficient to perform the transaction; and
when the amount of the cryptocurrency corresponding to the wallet address data on the blockchain network is sufficient to perform the transaction, transmitting a multi-signature wallet transaction data to the blockchain network for validating a blockchain operation, and sending a confirmation data of the transaction associated with the transaction application data to an opposing party of the transaction, wherein the multi-signature wallet transaction data includes the wallet address data, the user's signature data and a signature date of the authenticating server.

2. The authenticating server according to claim 1, wherein the user's signature data is a digital signature of the user corresponding to the wallet address data.

3. The authenticating server according to claim 1, wherein the transaction application data further comprises a transaction content and an opposing party data.

4. The authenticating server according to claim 3, wherein the multi-signature wallet transaction data further comprises the transaction content and the opposing party data.

5. The authenticating server according to claim 1, wherein when the amount of the cryptocurrency corresponding to the wallet address data on the blockchain network is insufficient to perform the transaction, the authenticating server further sends a transaction fail information to the user and does not send the multi-signature wallet transaction data to the blockchain network.

6. The authenticating server according to claim 1, wherein the cryptocurrency is selected from the group consisting of Bitcoin (BTC), Bitcoin cash (BCC), Ethereum (ETH), Litecoin (LTC) and Monero (XMR).

7. The authenticating server according to claim 1, wherein when the amount of the cryptocurrency corresponding to the wallet address data on the blockchain network is sufficient to perform the transaction, the authenticating server further sends the confirmation data to the user.

8. An authenticating method for transactions on blockchain, comprising steps:
an authenticating server receiving a transaction application data from a user, wherein the transaction application data includes a wallet data containing a wallet address data and a user's signature data;
the authenticating server checking whether an amount of a cryptocurrency corresponding to the wallet address data on the blockchain network is sufficient to perform the transaction; and
when the amount of the cryptocurrency corresponding to the wallet address data on the blockchain network is sufficient to perform the transaction, the authenticating server transmitting a multi-signature wallet transaction data to the blockchain network for validating a blockchain operation, and sending a confirmation data of the transaction associated with the transaction application data to an opposing party of the transaction, wherein the multi-signature wallet transaction data includes the wallet address data, the user's signature data and a signature date of the authenticating server.

9. The authenticating method according to claim 8, wherein the user's signature data is a digital signature of the user corresponding to the wallet address data.

10. The authenticating method according to claim 8, wherein the transaction application data further comprises a transaction content and an opposing party data.

11. The authenticating method according to claim 10, wherein the multi-signature wallet transaction data further comprises the transaction content and the opposing party data.

12. The authenticating method according to claim 8, wherein when the amount of the cryptocurrency corresponding to the wallet address data on the blockchain network is insufficient to perform the transaction, the authenticating server further sends a transaction fail information to the user and does not send the multi-signature wallet transaction data to the blockchain network.

13. The authenticating method according to claim 8, wherein the cryptocurrency is selected from the group consisting of Bitcoin (BTC), Bitcoin cash (BCC), Ethereum (ETH), Litecoin (LTC) and Monero (XMR).

14. The authenticating method according to claim 8, wherein when the amount of the cryptocurrency corresponding to the wallet address data on the blockchain network is sufficient to perform the transaction, the authenticating server further sends the confirmation data to the user.
